(19) United States
(12) Patent Application Publication
(10) Pub. No.: US 2019/0393597 A1
(43) Pub. Date: Dec. 26, 2019

(54) ANTENNA, MULTIBAND ANTENNA, AND WIRELESS COMMUNICATION DEVICE

(71) Applicant: NEC Corporation, Minato-ku, Tokyo (JP)

(72) Inventors: Keishi KOSAKA, Tokyo (JP); Hiroshi TOYAO, Tokyo (JP)

(73) Assignee: NEC Corporation, Minato-ku, Tokyo (JP)

(21) Appl. No.: 16/491,636

(22) PCT Filed: Mar. 20, 2018
(86) PCT No.: PCT/JP2018/011029

§ 371 Date: Sep. 6, 2019

(30) Foreign Application Priority Data
Mar. 31, 2017 (JP) 2017-071244

(51) Int. Cl. H01Q 1/52; H01Q 5/10; H01Q 15/14

(52) U.S. Cl. CPC H01Q 1/523; H01Q 9/0407; H01Q 15/14; H01Q 5/10

(57) ABSTRACT

The purpose of the present invention is to solve the problem that, when a plurality of antennas corresponding to mutually different frequency bands are alternately arranged, if the antenna interval is narrowed, one antenna is subjected to the influence of another antenna adjacent thereto, resulting in a decrease in performance (such as bandwidth or radiation pattern). Accordingly, the present invention provides an antenna of which an operation frequency is in a first frequency band. The antenna is provided with a radiating conductor provided with a frequency selection plate, and a feeder portion for supplying electric power to the radiating conductor, wherein the frequency selection plate is transmissive to electromagnetic waves of a second frequency band different from the first frequency band.

### TECHNICAL FIELD

The present invention relates to an antenna, a multiband antenna, and a wireless communication device.

### BACKGROUND ART

In recent years, as an antenna for a mobile communication base station and a Wi-Fi communication equipment antenna device, a multiband antenna capable of communicating in a plurality of frequency bands has been put into practical use in order to ensure a communication capacity.

One example of a multiband antenna is disclosed in Patent Literature 1 (PTL1). A multiband antenna described in PTL1 includes a plurality of dipole antennas corresponding to mutually different frequency bands. Such a multiband antenna is configured by an arrangement in which cross-dipole antennas for a high bandwidth and a low bandwidth are alternately arranged on an antenna reflector. When plural stages of such arrangement are further provided, the multiband antenna includes a central conductor fence among a plurality of arrangements. The central conductor fence is configured in such a way as to reduce mutual coupling between high-bandwidth antenna elements adjacent to each other and between low-bandwidth antenna elements adjacent to each other.

### CITATION LIST

### Patent Literature

[PTL1] International Publication No. WO 2014/059946

### SUMMARY OF INVENTION

### Technical Problem

When a plurality of antennas corresponding to mutually different frequency bands are alternately arranged as described above, performance (a bandwidth, a radiation pattern and the like) of one antenna is degraded by being subjected to an influence of another antenna adjacent thereto when an antenna interval is narrowed. The reason is that an electromagnetic wave radiated from the one antenna is reflected by the another antenna that is a metallic body, and a reflection wave thereof changes a state of the electromagnetic wave radiated by the one antenna.

An object of the present invention is to provide an antenna, a multiband antenna, and a wireless communication device capable of disposing a plurality of antennas corresponding to mutually different frequency bands at a short distance by reducing an influence on another antenna through reduction of reflection of an electromagnetic wave.

### Solution to Problem

A antenna in an embodiment of the present invention relates to an antenna in which operation frequency is in a first frequency band, includes: a radiating conductor including a frequency selective surface; and a feeding part that supplies electric power to the radiating conductor, wherein the frequency selective surface transmits an electromagnetic wave of a second frequency band which is different from the first frequency band.

A multiband antenna in an embodiment of the present invention, includes: a first antenna an operation frequency of which is in a first frequency band, the first antenna including a first radiating conductor; a second antenna an operation frequency of which is in a second frequency band being different from the first frequency band, the second antenna including a second radiating conductor; and a feeding part that supplies electric power to the first radiating conductor and the second radiating conductor, wherein the first radiating conductor includes a frequency selective surface that transmits an electromagnetic wave of the second frequency band.

A wireless communication device in an embodiment of the present invention, includes: a BB unit that outputs a base band (BB) signal; an RF unit that converts the BB signal to a radio frequency (RF) signal and outputs the RF signal; and an antenna to which the RF signal is input, wherein the antenna includes a feeding part that supplies electric power to a radiating conductor, operation frequency of the antenna is in a first frequency band, and the radiating conductor includes a frequency selective surface transmitting an electromagnetic wave of a second frequency band which is different from the first frequency band.

A wireless communication device in an embodiment of the present invention, includes: a BB unit that outputs a base band (BB) signal; an RF unit that converts the BB signal to a radio frequency (RF) signal and outputs the RF signal; and a multiband antenna to which the RF signal is input, wherein the multiband antenna comprises: a first antenna including a first radiating conductor and an operation frequency of which being in a first frequency band; a second antenna including a second radiating conductor and an operation frequency of which being in a second frequency band; and a feeding part that supplies electric power to the first radiating conductor and the second radiating conductor, and wherein the first radiating conductor includes a frequency selective surface transmitting an electromagnetic wave of a second frequency band.

### Advantageous Effects of Invention

According to the present invention, antennas corresponding to mutually different frequency bands can be disposed at a short distance, and therefore a size of an entire device can be reduced.

### BRIEF DESCRIPTION OF DRAWINGS

FIG. 1 is a diagram illustrating a configuration of an antenna 10 in a first example embodiment of the present invention.

FIG. 2 is a diagram illustrating an operational effect of the antenna 10 in the first example embodiment of the present invention.

FIG. 3 is a diagram illustrating an operational effect of the antenna 10 in the first example embodiment of the present invention.

FIG. 4 is a diagram illustrating a configuration of the antenna 10 in the first example embodiment of the present invention.

FIG. 5 is a diagram illustrating a configuration of the antenna 10 in the first example embodiment of the present invention.

FIG. 6 is a diagram illustrating a configuration of an FSS 103 in the first example embodiment of the present invention.

FIG. 7 is a diagram illustrating a configuration of the FSS 103 in the first example embodiment of the present invention.

FIG. 8 is a diagram illustrating a configuration of the FSS 103 in the first example embodiment of the present invention.

FIG. 9 is a diagram illustrating a configuration of the FSS 103 in the first example embodiment of the present invention.

FIG. 10 is a diagram illustrating a configuration of the FSS 103 in the first example embodiment of the present invention.

FIG. 11 is a diagram illustrating a configuration of the FSS 103 in the first example embodiment of the present invention.

FIG. 12 is a diagram illustrating a configuration of the FSS 103 in the first example embodiment of the present invention.

FIG. 13 is a diagram illustrating a configuration of an FSS 1030 in the first example embodiment of the present invention.

FIG. 14 is a diagram illustrating a configuration of an antenna 20 in a second example embodiment of the present invention.

FIG. 15 is a diagram illustrating a configuration of an antenna 30 in a third example embodiment of the present invention.

FIG. 16 is a diagram illustrating a configuration of the antenna 30 in the third example embodiment of the present invention.

FIG. 17 is a diagram illustrating a configuration of the antenna 30 in the third example embodiment of the present invention.

FIG. 18 is a diagram illustrating a configuration of the antenna 30 in the third example embodiment of the present invention.

FIG. 19 is a diagram illustrating a configuration of the antenna 30 in the third example embodiment of the present invention.

FIG. 20 is a diagram illustrating a configuration of the antenna 30 in the third example embodiment of the present invention.

FIG. 21 is a diagram illustrating a configuration of the antenna 30 in the third example embodiment of the present invention.

FIG. 22 is a diagram illustrating a configuration of the antenna 30 in the third example embodiment of the present invention.

FIG. 23 is a diagram illustrating a configuration of an antenna 40 in a fourth example embodiment of the present invention.

FIG. 24 is a diagram illustrating a configuration of the antenna 40 in the fourth example embodiment of the present invention.

FIG. 25 is a diagram illustrating a configuration of a multiband antenna 50 in a fifth example embodiment of the present invention.

FIG. 26 is a diagram illustrating a configuration of the multiband antenna 50 in the fifth example embodiment of the present invention.

FIG. 27 is a diagram illustrating a configuration of the multiband antenna 50 in the fifth example embodiment of the present invention.

FIG. 28 is a diagram illustrating a configuration of the multiband antenna 50 in the fifth example embodiment of the present invention.

FIG. 29 is a diagram illustrating a configuration of a multiband antenna array 60 in a sixth example embodiment of the present invention.

FIG. 30 is a diagram illustrating a configuration of the multiband antenna array 60 in the sixth example embodiment of the present invention.

FIG. 31 is a diagram illustrating a configuration of the multiband antenna array 60 in the sixth example embodiment of the present invention.

FIG. 32 is a diagram illustrating a configuration of a multiband antenna array 61 in the sixth example embodiment of the present invention.

FIG. 33 is a diagram illustrating a configuration of a wireless communication device 70 in a seventh example embodiment of the present invention.

FIG. 34 is a diagram illustrating a configuration of the wireless communication device 70 in the seventh example embodiment of the present invention.

### EXAMPLE EMBODIMENT

Hereinafter, example embodiments of the present invention are described in detail with reference to the drawings. In drawings and example embodiments described in the description, a component including a similar function is assigned with a similar reference sign. Components described in the following example embodiments are merely illustrative and are not intended to limit the technical scope of the present invention only to these components.

### First Example Embodiment

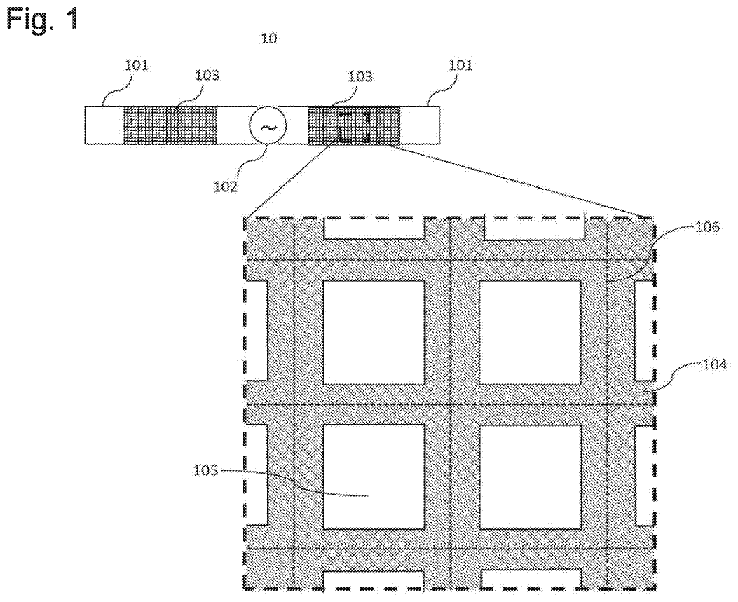

An antenna 10 as a first example embodiment of the present invention is described by using FIG. 1. The antenna 10 is an antenna including a frequency selective surface (hereinafter, referred to as a frequency selective surface/sheet (FSS)).

As illustrated in FIG. 1, the antenna 10 includes two radiating conductors 101 and a feeding point 102. The two radiating conductors 101 include an FSS 103 in a resonator portion. The FSS 103 may be disposed in a portion other than the resonator portion. The FSS 103 includes a conductor part 104 and a void part 105. The antenna 10 is designed in such a way as to operate in a predetermined frequency band f1. f1 is referred to as an operation frequency band.

The radiating conductor 101 has a length of substantially one quarter of a wavelength λ1 of an operation frequency band f1 in a longitudinal direction. The antenna 10 includes two radiating conductors 101 and therefore has a length of substantially one half of a wavelength λ1 in a longitudinal direction. The radiating conductor 101 includes an FSS 103.

The feeding point 102 is supplied with high-frequency electric power from a power source (not illustrated). The feeding point 102 electrically excites the two radiating conductors 101 in the operation frequency band f1 by using the supplied electric power. The feeding point 102 may be referred to as a feeding part and supplies electric power to the radiating conductor 101.

Based on the configuration described above, the antenna 10 operates as a dipole antenna that operates in an operation frequency band f1.

In general, an FSS is a plate-like structured body including any one of a conductor, a periodical structure of conductors, a conductor and a dielectric, or a periodical structure of conductors and dielectrics. An FSS is generally used for a reflective plate, a radome or the like, and includes a function of selectively transmitting or reflecting an electromagnetic wave of a specific frequency band entering a plate surface.

The FSS 103 is provided in a resonator portion of the radiating conductor 101. The FSS 103 may be disposed in a portion other than the resonator portion of the radiating conductor 101. The FSS 103 has a periodical structure including the conductor part 104 and the void part 105. The FSS 103 includes a function of transmitting an electromagnetic wave of a frequency band f2 different from an operation frequency band f1.

The radiating conductor 101, the conductor part 104, and those to be described as a conductor in the following description include, for example, metal such as copper, silver, aluminum, and nickel, or another good conductor material.

The radiating conductor 101 and the FSS 103 may be produced by sheet-metal processing or a common substrate production process for a printed circuit board having a dielectric layer, a semiconductor substrate, or the like.

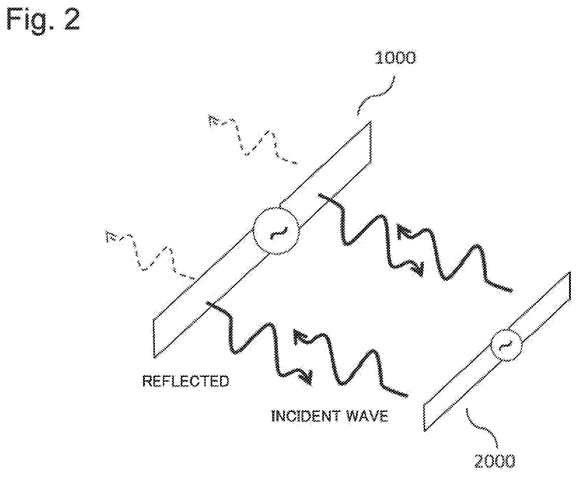

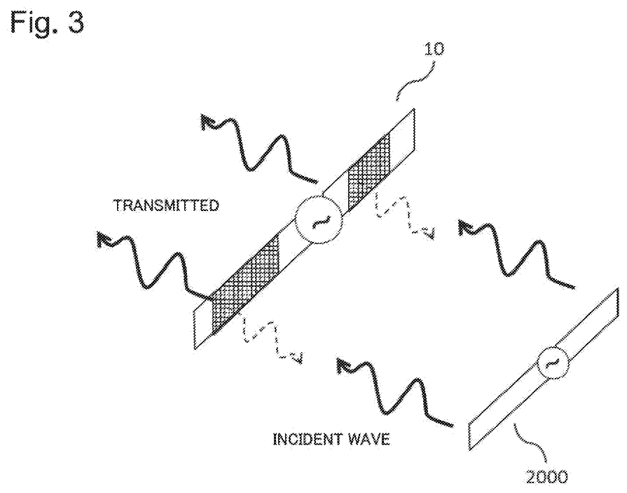

An operation and an effect of the antenna 10 is described by using FIGS. 2 and 3.

As illustrated in FIG. 2, a common antenna 1000 that operates in a frequency band f1 includes a conductor having a size of approximately one half of a wavelength λ1 of f1 and therefore reflects a majority of an electromagnetic wave of a frequency band f2 (specifically, f2>f1) entering the antenna 1000 and changes a state of the electromagnetic wave of the frequency band f2 (e.g. a radiation pattern of an antenna 2000 that operates in the frequency band f2 is changed). In other words, the antenna 1000 inhibits, for example, an operation of the antenna 2000 disposed in a vicinity.

Therefore, a case in which the antenna 1000 that operates in a frequency band f1 is replaced with the antenna 10 of FIG. 1 is considered. In this case, the antenna 10 transmits an electromagnetic wave of a frequency band f2 in the FSS 103. It is conceivable that a portion other than the FSS 103 in the radiating conductor 101 is one or a plurality of small conductor pieces, as illustrated in FIG. 1. Especially, when a size of an individual conductor piece is less than one half of a wavelength λ2 of the frequency band f2, in characteristics of the individual conductor piece with respect to an electromagnetic wave of the frequency band f2 entering the antenna 10, transmission is a dominant characteristic. As a result, as illustrated in FIG. 3, the antenna 10 can transmit a majority of an incident electromagnetic wave of the frequency band f2 and therefore can suppress a change of a state of the electromagnetic wave of the frequency band f2. In other words, the antenna 10 can reduce, for example, an influence on the antenna 2000 disposed in a vicinity and operates in the frequency band f2.

Herein, an influence on the antenna 10 produced when the antenna 1000 is replaced with the antenna 10, that is, the antenna 1000 includes the FSS 103, is minimal. In other words, the antenna 10 can use the antenna 1000 as is or the antenna 1000 a design of which is slightly adjusted. Especially when the FSS 103 has characteristics of reflecting an incident electromagnetic wave of a frequency band f1 similarly to when including merely a conductor plate, it is nearly impossible to discriminate the FSS 103 from a conductor before replacement for the electromagnetic wave of the frequency band f1. In other words, the FSS 103 does not affect the electromagnetic wave of the frequency band f1.

As described above, the antenna 10 of the first example embodiment includes the FSS 103 and thereby can reduce an influence on an electromagnetic wave of a frequency band different from an operation frequency band.

As described above, in f2>f1, an advantageous effect of the FSS 103 is notable, and also in f1>f2, an advantageous effect of the present invention can be produced.

While in FIG. 1, the FSS 103 includes the conductor part 104 and the void part 105, a configuration of the FSS 103 is not limited thereto. The FSS 103 may be an FSS having transmission characteristics of an electromagnetic wave in a frequency band f2.

The FSS 103 preferably has characteristics of reflecting an electromagnetic wave in a frequency band f1, similarly to a conductor plate, as described above. However, the FSS 103 may have any characteristics with respect to an electromagnetic wave of a frequency band f1 in a range where there is no obstacle to an operation of the antenna 10 in the frequency band f1.

In FIG. 1, the FSS 103 has a periodical structure based on the conductor part 104 and the void part 105, but the number of periodical structures is not specifically limited. The FSS 103 may be, for example, an FSS in which the number of repetitive units (hereinafter, unit cells 106) configuring a periodical structure is only one according to predetermined transmission characteristics of an electromagnetic wave of a frequency band f2. Further, a periodical structure in the FSS 103 may not be strictly periodical, and structures of unit cells 106 may slightly differ from each other according to predetermined transmission characteristics. Further, while a periodical structure in the FSS 103 has a substantially square shape in FIG. 1, the shape is not limited thereto, and a rectangle, a triangle, a hexagon, other polygons, a circle and the like are applicable.

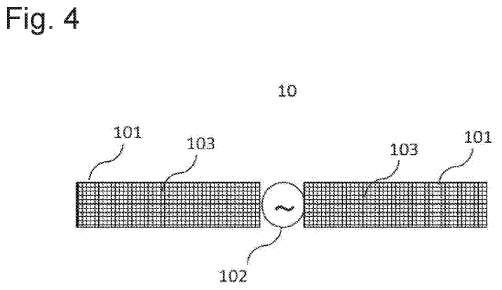

In FIG. 1, the antenna 10 includes the FSS 103 in a part of the radiating conductor 101. However, the FSS 103 is not necessarily a part of the radiating conductor 101 and the entire radiating conductor 101 of the antenna 10 may be configured by using the FSS 103, as illustrated in FIG. 4.

In FIG. 1, a size of a portion (one or each of a plurality of conductor pieces) other than the FSS 103 of the radiating conductor 101 is preferably smaller than one half of λ2, as described above. However, the size is not necessarily one half of λ2 according to predetermined characteristics of the antenna 10 for an electromagnetic wave of a frequency band f2.

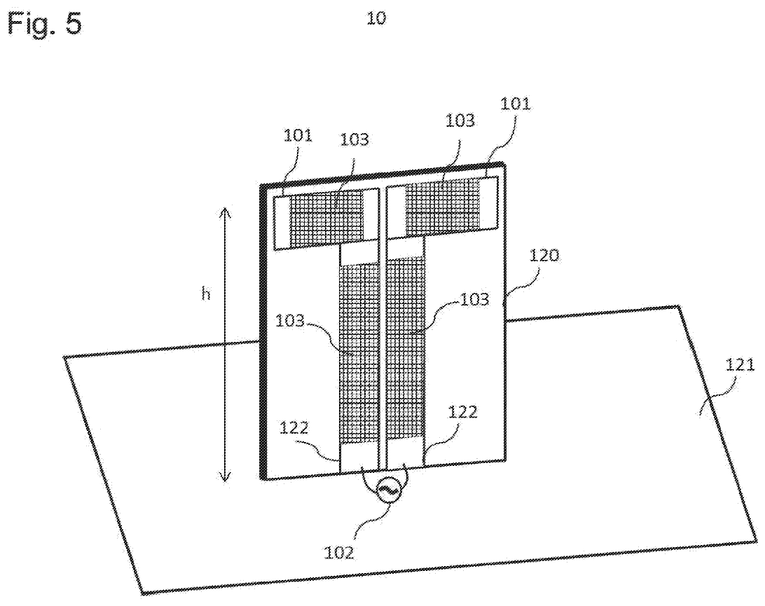

The antenna 10 is not limited to the configuration of FIG. 1 or 2 and may be, for example, a dipole antenna formed with a conductor pattern provided on or in a dielectric substrate 120, as illustrated in FIG. 5. As illustrated in FIG. 5, the antenna 10 may include a conductor reflection plate 121 and two feed-line conductor parts 122. In this case, the two radiating conductors 101 are placed at a position away from the conductor reflection plate 121 at a distance h in a vertical direction. One end of each of the two feed-line conductor parts 122 is electrically connected to each of ends adjacent to each other of the two radiating conductors 101. The other end of each of the feed-line conductor parts 122 is extended as a feed line from the radiating conductor 101 to the conductor reflection plate 121 and is connected to the feeding point 102. At that time, the FSS 103 may configure a part or the whole of the feed-line conductor part 122, in addition to the radiating conductor 101, as illustrated in FIG. 5. Further, while not illustrated in FIG. 5, the FSS 103 may configure a part or the whole of the conductor reflection plate 121, in addition to the radiating conductor 101 and the feed-line conductor part 122. Thereby, the antenna 10 can cause a conductor portion other than the radiating conductor 101 to have transmission characteristics with respect to an electromagnetic wave of a frequency band f2. The distance h is preferably approximately one quarter of λ1.

The antenna 10 is a dipole antenna in FIGS. 1, 4, and 5 but may be not necessarily a dipole antenna. The antenna 10 may be, for example, an antenna including an FSS in a resonator portion in an antenna of another type such as a monopole antenna, a patch antenna, and a slot antenna.

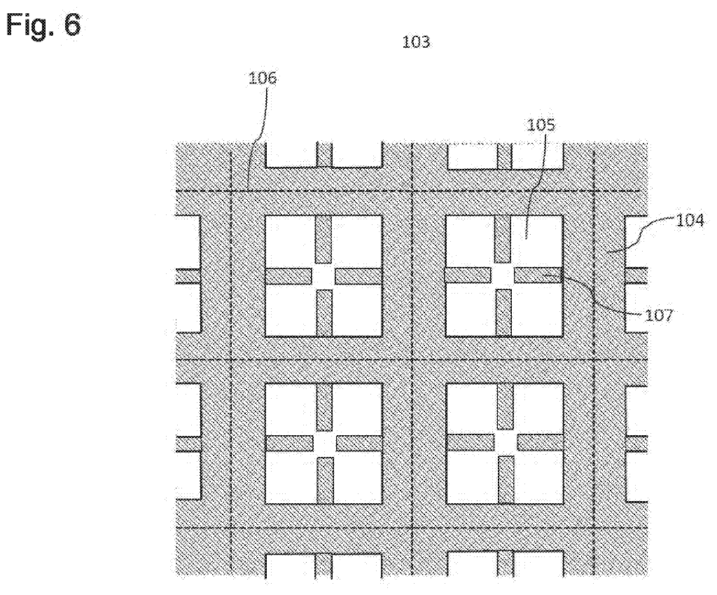

Hereinafter, a modified example of the FSS 103 in the present example embodiment is described by using FIGS. 6 to 13.

FIG. 6 illustrates a top view of one form of the modified example of the FSS 103. An FSS 103 illustrated in FIG. 6 further includes a plurality of conductor parts 107, in addition to the FSS 103 illustrated in FIG. 1. FIG. 6 illustrates a case in which four conductor parts 107 are included with respect to a unit cell 106.

The conductor part 107 is provided in the void part 105, and one end is electrically connected to a conductor part 104 and the other end is opposed to another conductor part 107 with a gap. When the conductor part 107 is disposed in this manner, in the void part 105, a distance between conductors opposed to each other with a gap therebetween is shortened and an electric capacitance can be adjusted or increased.

Hereinafter, an advantageous effect of increasing capacitance by use of the conductor part 107 is described.

An FSS includes an electromagnetic resonance structure in which a resonance occurs in a specific frequency band for which the FSS performs selective transmission or reflection.

The FSS 103 illustrated in FIG. 1 has a resonance structure in which a resonance occurs in a frequency band f2 and transmits an electromagnetic wave of the frequency band f2. Specifically, the FSS 103 illustrated in FIG. 1 includes a conductor part 104 loop-shaped by the void part 105 in the unit cell 106. An electric length of the loop-like conductor part 104 is close to one wavelength of an electromagnetic wave of the frequency band f2, and thereby the conductor part 104 electromagnetically resonates in the frequency band f2. The resonance based on the one wavelength conductor loop can be described otherwise as follows. The FSS 103 illustrated in FIG. 1 electromagnetically resonates based on an inductance based on the conductor part 104 loop-shaped by the void part 105 in the unit cell 106 and a capacitance between conductor parts 104 opposed to each other with a gap based on the void part 105.

In an FSS 103 illustrated in FIG. 6, a distance between conductors opposed to each other with a gap can be adjusted by the conductor part 107, and therefore a size of a capacitance can be adjusted. When, for example, the void part 105 is reduced in size and a unit cell 106 is reduced in size, the unit cell 106 can be made smaller without changing a resonance frequency by increasing a capacitance by the conductor part 107 for a reduced amount of an inductance based on the conductor part 104. Therefore, a unit cell can be made small by the conductor part 107 without changing transmission characteristics of the FSS 103, and thereby a degree of design freedom is enhanced and a part of the radiating conductor 101 can be easily replaced with the FSS 103.

A shape of the conductor part 107 is not limited to the structure illustrated in FIG. 6. The conductor part 107 may have any shape as long as the shape changes a distance between conductors opposed to each other with a gap therebetween in the void part 105.

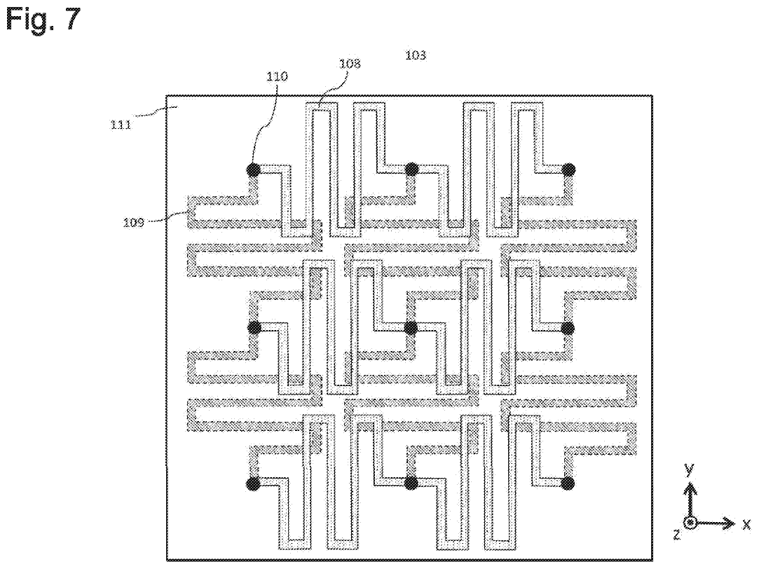

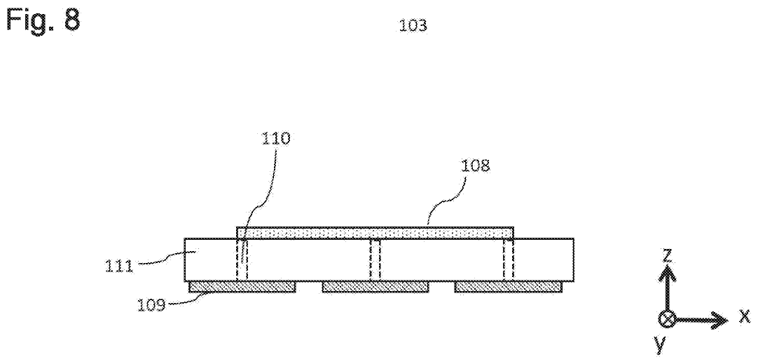

FIG. 7 illustrates a top view (xy plan view) of one form of the modified example of the FSS 103, and FIG. 8 illustrates a front view (xz plan view) of one form of the modified example of the FSS 103.

An FSS 103 illustrated in FIGS. 7 and 8 includes, instead of the conductor part 104, a mesh-like conductor including meander-like conductor parts 108 and 109 and a conductor via 110.

The meander-like conductor parts 108 and 109 are meander-like conductors disposed in different layers across a dielectric part 111.

The conductor via 110 is a conductor electrically connecting the meander-like conductor parts 108 and 109 by penetrating the dielectric part 111.

The FSS 103 illustrated in FIGS. 7 and 8 is configured by using a mesh-like conductor connected across a plurality of layers based on the meander-like conductor parts 108 and 109 and the conductor via 110. This can provide one wavelength conductor loop that is a resonance structure determining the above-described transmission characteristics of the FSS 103 in an area smaller than for FIG. 1 or 6. The reason is that an inductance per unit length of a circumferential direction of a conductor loop is increased by using a meander shape of the meander-like conductor parts 108 and 109 and thereby an effective electric length of a loop can be ensured in a small area. In addition, in the FSS 103 illustrated in FIGS. 7 and 8, the meander-like conductor parts 108 and 109 are provided in different layers, and thereby the meander-like conductor parts 108 and 109 can form meanders in such a way as to be overlapped when viewed from a top surface as illustrated in FIG. 7. Therefore, area efficiency upon formation of a meander is improved, compared with a single layer and an inductance can be further increased. Note that, the inventors have confirmed that even when in this manner, conductors in a circumferential direction of a conductor loop that is a resonance structure of an FSS are provided in different layers in order to increase an inductance and are overlapped when viewed from a top view, transmission or reflection characteristics of an electromagnetic wave entering the FSS are not adversely effected.

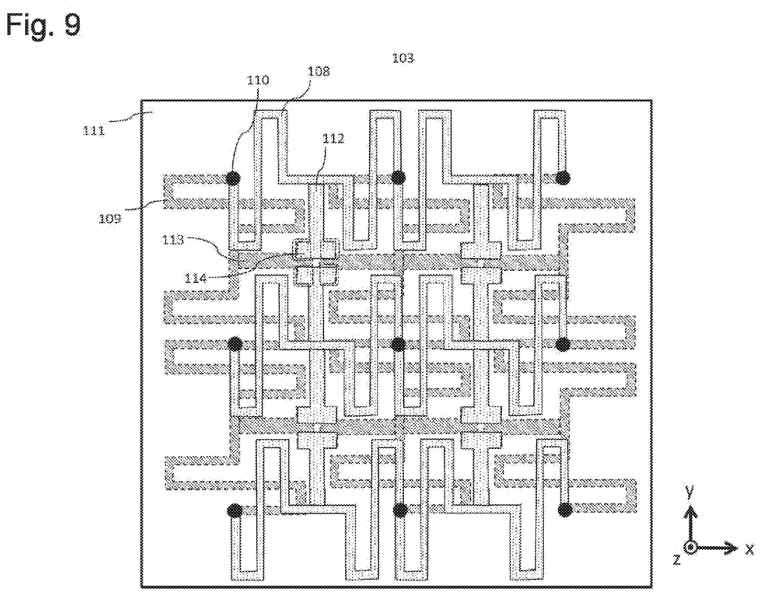

FIG. 9 illustrates a top view of one form of the modified example of the FSS 103. An FSS 103 illustrated in FIG. 9 further includes a plurality of conductor parts 112 and 113, in addition to the configuration of the FSS 103 illustrated in FIGS. 7 and 8. The conductor parts 112 and 113 are equivalent to the conductor part 107 in FIG. 6. One end of the conductor part 112 is connected to a meander-like conductor part 108 and the other end is opposed to another conductor part 112 with a gap therebetween. Similarly, one end of the conductor part 113 is connected to a meander-like conductor part 109 and the other end is opposed to another conductor part 113 with a gap therebetween. When the conductor parts 112 and 113 are disposed in this manner, a distance between conductors opposed to each other with a gap can be shortened and an electric capacitance can be adjusted or increased. In other words, based on the conductor parts 112 and 113, the FSS 103 illustrated in FIG. 9 can further reduce a size of a unit cell than the FSS 103 illustrated in FIGS. 7 and 8 by an advantageous effect similar to the conductor part 107. While in a unit cell, a plurality of conductor parts 112 and a plurality of conductor parts 113 are provided in the same layers, and are opposed with a gap in an xy plane in FIG. 9, the conductor parts 112 and the conductor part 113 can be opposed in a z direction in FIG. 9 via a dielectric part 111, as illustrated in FIG. 9. At that time, either of the plurality of conductor parts 112 or the plurality of conductor parts 113 acts as an auxiliary conductor when the other forms a capacitance and can increase the capacitance. The advantageous effect as the auxiliary conductor is larger as an area formed by causing the conductor part 112 and the conductor part 113 to be opposed via the dielectric part 111 increases. Therefore, in the FSS 103 illustrated in FIG. 9, a portion where the plurality of conductor parts 112 and the plurality of conductor parts 113 are opposed to each other via the dielectric part 111 in a unit cell is widened by a conductor part 114 in FIG. 9. By using the conductor part 114, an area of a portion where the plurality of conductor parts 112 and the plurality of conductor parts 113 are opposed to each other and an area of a portion where the conductor part 112 and the conductor part 113 are opposed to each other via the dielectric part 111 can be increased at the same time. In other words, the conductor part 114 produces an advantageous effect of further increasing the capacitance described above.

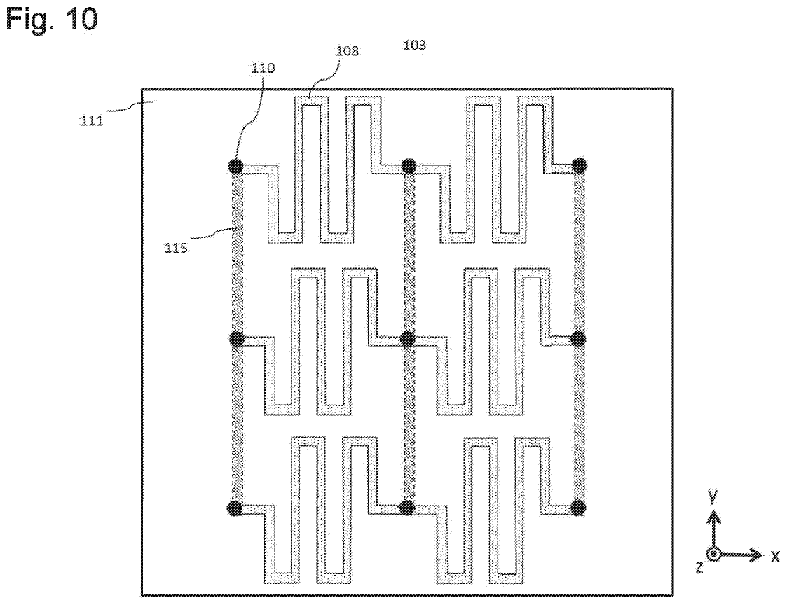

FIG. 10 illustrates a top view of one form of the modified example of the FSS 103. An FSS 103 illustrated in FIG. 10 includes a linear conductor part 115, instead of either of the meander-like conductor parts 108 or 109 (the meander-like conductor part 109 in FIG. 10) in the structure of the FSS 103 illustrated in FIGS. 7 and 8. In this manner, the FSS 103 may not necessarily have electric symmetry in two directions on a plane parallel to the FSS 103. In this case, electromagnetic wave transmission characteristics or reflection characteristics possessed by the FSS 103 can be caused to be a nature different with respect to each polarized wave of an incident electromagnetic wave.

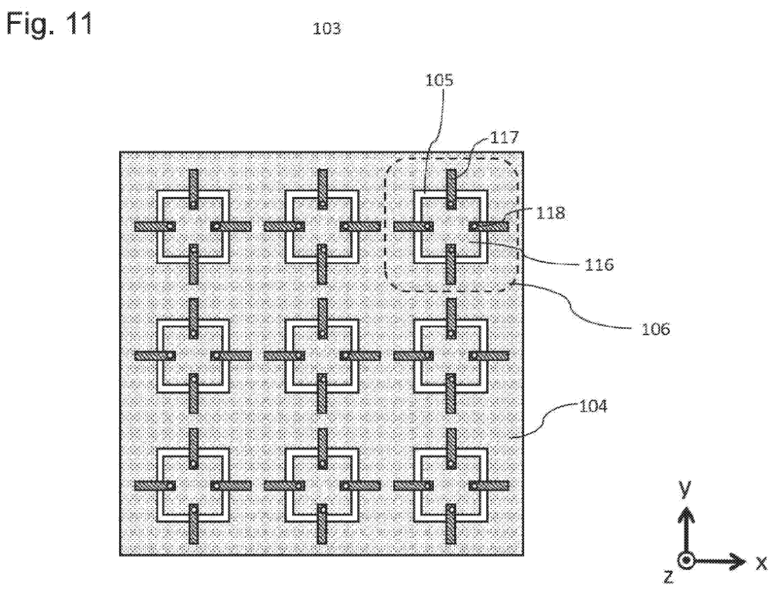

FIG. 11 illustrates a top view of one form of the modified example of the FSS 103. The FSS 103 illustrated in FIG. 11 further includes a conductor patch 116, an open stub 117, and a conductor pin 118, in addition to the configuration of the FSS 103 illustrated in FIG. 1.

The conductor patch 116 is provided in the same layer as the conductor part 104 in the void part 105 without making contact with the conductor part 104.

The open stub 117 is provided in a layer different from the conductor patch 116 and the conductor part 104 by straddling the conductor patch 116 and the conductor part 104. One end of the open stub 117 is open and the other end thereof is connected to the conductor patch 116 by the conductor pin 118.

The conductor pin 118 is electrically connected to the open stub 117 and the conductor patch 116.

Based on an adjusting structure including the conductor patch 116, the open stub 117, and the conductor pin 118, the FSS 103 illustrated in FIG. 11 adjusts a length of the open stub 117 and thereby adjust or increase a capacitance formed by conductor parts opposed to each other with a gap therebetween, without changing a size of a unit cell 106. In other words, the FSS 103 adjusts the length of the open stub 117 and thereby can change a frequency band of an electromagnetic wave to be transmitted. When the length of the open stub 117 is increased, a capacitance is increased, and therefore a characteristic (resonance frequency) of a resonance structure is shifted to a lower band. At that time, a frequency band of an electromagnetic wave transmitted by the FSS 103 is changed to a lower band.

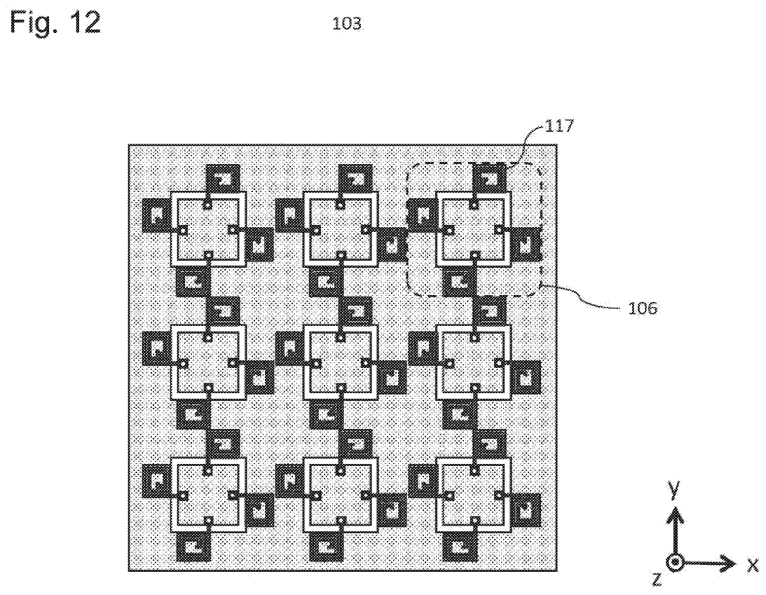

In the present modified example, the open stub 117 is linear. However, the open stub 117 may have a spiral shape as illustrated in FIG. 12 or may have another shape. By having a spiral shape, the open stub 117 can ensure a length within a limited space.

In the present modified example, while four adjusting structures of a capacitance are provided for the unit cell 106, the number of adjusting structures of a capacitance is not limited thereto.

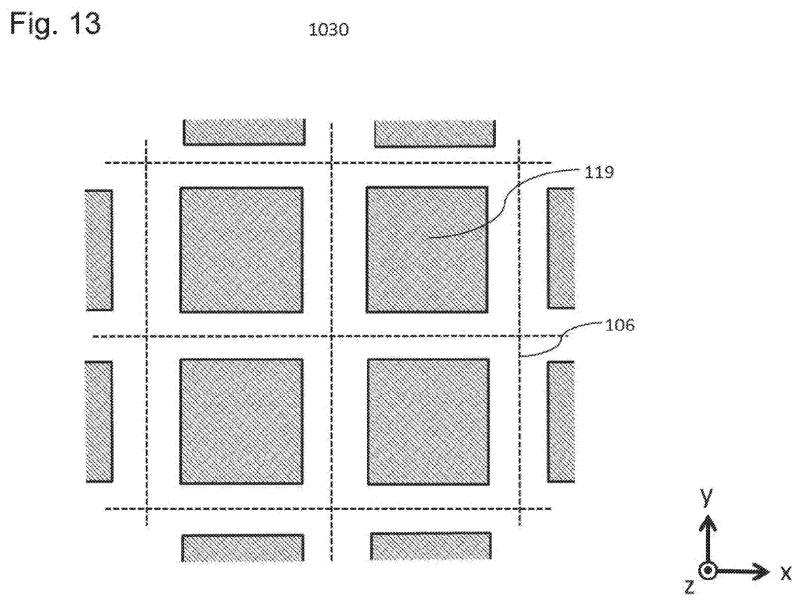

FIG. 13 illustrates a top view of one form of an FSS 1030 that is a further modified example of the FSS 103. The FSS 1030 illustrated in FIG. 13 includes a plurality of conductor patches 119 disposed with a substantially periodical gap on a plane. The FSS 103 illustrated in FIGS. 1 and 6 to 12 includes conductors connected in a substantially mesh-like manner and selectively transmits a frequency band f2. However, an FSS may have a patch shape in which conductor portions are not electrically connected in a unit cell 106 or between unit cells 106 adjacent to each other, as illustrated in FIG. 13. However, the FSS 1030 in FIG. 13 has characteristics that selectively reflect an electromagnetic wave in a resonance frequency band of a resonance structure based on an inductance possessed by the conductor patch 119 and a capacitance between conductor patches 119 adjacent to each other. Therefore, when the FSS 1030 of FIG. 13 is used as the FSS 103 of the antenna 10, the FSS 1030 has characteristics that transmit an incident electromagnetic wave in a frequency band f2, and therefore the resonance frequency band described above needs to have a value separate from the frequency band f2. Only when the FSS 1030 has characteristics that transmit an incident electromagnetic wave in the frequency band f2, the radiating conductor 101 illustrated in FIG. 1 may include the FSS 1030 of FIG. 13. In this case, the antenna 10 includes the FSS 1030 and operates in a frequency band f1, and therefore it may be necessary to separately adjust an electromagnetic behavior of the FSS 1030 in the frequency band f1.

### Second Example Embodiment

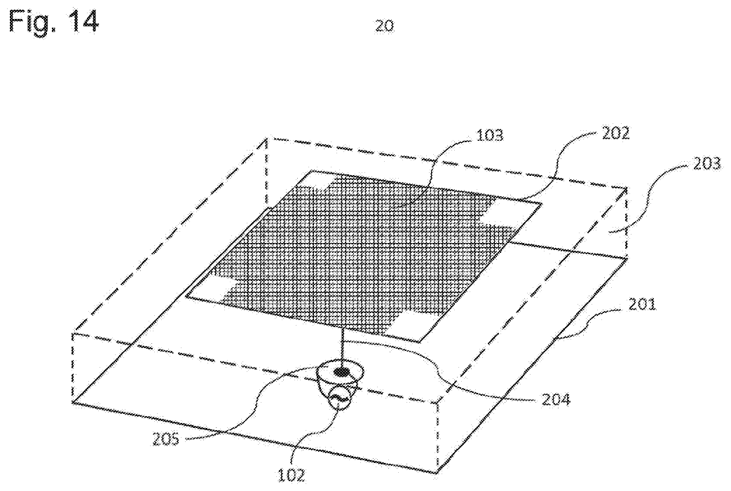

FIG. 14 is a configuration diagram illustrating a configuration of an antenna 20 in a second example embodiment of the present invention. The present example embodiment is different from the first example embodiment in that a dipole antenna in the first example embodiment is replaced with a patch antenna. In the present example embodiment, the same component as in the first example embodiment is assigned with the same reference sign, and therefore detailed description is omitted.

The antenna 20 is a patch antenna including an FSS 103 in a resonator portion. The FSS 103 may be disposed in a portion other than the resonator portion. Referring to FIG. 14, the antenna 20 includes a conductor reflection plate 201, a conductor patch 202, a dielectric substrate 203, a conductor via 204, and a feeding point 102.

Hereinafter, components included in the antenna 20 in the second example embodiment are described.

The conductor reflection plate 201 and the conductor patch 202 are disposed substantially in parallel across the dielectric substrate 203. The conductor reflection plate 201 includes a void part 205 for supplying electric power.

The conductor patch 202 includes an FSS 103. In other words, a part or the whole of the conductor patch 202 is replaced with the FSS 103.

The conductor via 204 penetrates the dielectric substrate 203, and one end thereof is connected to the conductor patch 202 and the other end thereof is disposed in such a way as to be located in the void part 205.

The feeding point 102 is provided between the conductor reflection plate 201 and the conductor via 204.

An electric length of one side of the conductor patch 202 including an effect of the dielectric substrate 203 is one half of λ1, and the conductor reflection plate 201, the conductor patch 202, the dielectric substrate 203, and the conductor via 204 form a patch antenna that operates in a frequency band f1.

An operation and an effect of the antenna 20 according to the second example embodiment is described.

Similarly to the first example embodiment, the antenna 20 has characteristics in which a portion of the FSS 103 transmits an electromagnetic wave of f2. Further, the remaining portion excluding the FSS 103 in the conductor patch 202 has a short length in a longitudinal direction as illustrated in FIG. 14, similarly to the first example embodiment and behaves as a small conductor piece with respect to an electromagnetic wave of f2, and therefore as characteristics for an incident electromagnetic wave of f2, transmission is dominant. As a result, the conductor patch 202 transmits a majority of an incident electromagnetic wave of a frequency band f2 and reduces an influence on the electromagnetic wave of the frequency band f2. Therefore, in the antenna 20, the conductor patch 202 can reduce, for example, an influence on an operation of a nearly-disposed antenna that operates in the frequency band f2.

### Third Example Embodiment

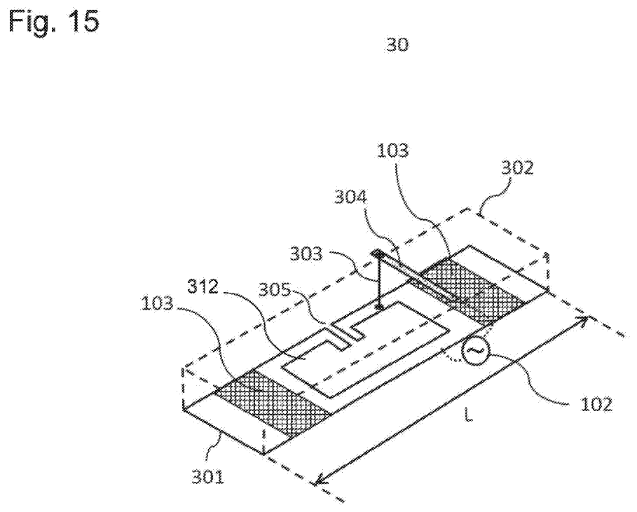

FIG. 15 is a configuration diagram illustrating a configuration of an antenna 30 in a third example embodiment of the present invention. The present example embodiment is different from the first example embodiment in that a dipole antenna in the first example embodiment is replaced with an antenna (split ring antenna) using a split ring resonator. In the present example embodiment, the same component as in other example embodiments is assigned with the same reference sign, and therefore detailed description is omitted.

An antenna 30 is an antenna including an FSS 103 in a split ring resonator portion. The FSS 103 may be disposed in a portion other than a split ring resonator portion. Referring to FIG. 15, the antenna 30 includes, as an antenna using a split ring resonator, an annular conductor part 301 of a substantial C-shape, a dielectric substrate 302, a conductor via 303, a conductor feed line 304, and a feeding point 102.

Hereinafter, components included in the antenna 30 in the third example embodiment are described.

As illustrated in FIG. 15, the annular conductor part 301 (a split ring resonator) is an annular conductor that surrounds a void 312 and a part thereof in a circumferential direction is notched by a split part 305. The annular conductor part 301 forms an inductance, based on an annular conductor and forms a capacitance between ends of the annular conductor part 301 opposed to each other via the split part 305. The antenna 30 using a split ring resonator that excites an electromagnetic resonance by using the inductance and capacitance can be reduced in dimension, compared with a dipole antenna of the same operation frequency. Specifically, in FIG. 15, a length L in a longitudinal direction of the annular conductor part 301 can be approximately one quarter of λ1. The annular conductor part 301 includes an FSS 103. In other words, a part or the whole of the annular conductor part 301 is replaced with the FSS 103.

The conductor feed line 304 is opposed to the annular conductor part 301 via the dielectric substrate 302. When viewed from a direction where the annular conductor part 301, the dielectric substrate 302, and the conductor feed line 304 are laminated, the conductor feed line 304 is disposed in such a way as to straddle the void 312. One end of the conductor feed line 304 is electrically connected to a vicinity of the split part 305 of the annular conductor part 301 via the conductor via 303. The other end of the conductor feed line 304 is connected to the feeding point 102.

The feeding point 102 is provided between the other end of the conductor feed line 304 and the annular conductor part 301.

The conductor via 303 penetrates the dielectric substrate 302, one end thereof is electrically connected to a neighborhood of the split part 305 of the annular conductor part 301, and the other end thereof is electrically connected to a vicinity of one end of the conductor feed line 304. Thereby, the conductor via 303 electrically connects the annular conductor part 301 and the conductor feed line 304.

An operation and an effect of the antenna 30 according to the third example embodiment is described.

Similarly to the first example embodiment, the antenna 30 has characteristics in which a portion of the FSS 103 transmits an electromagnetic wave of f2. Further, the remaining portion excluding the FSS 103 in the annular conductor part 301 has a short length in a longitudinal direction as illustrated in FIG. 15, similarly to the first example embodiment, and behaves like a small conductor piece with respect to an electromagnetic wave of f2, and therefore as characteristics for an incident electromagnetic wave of f2, transmission is dominant. As a result, the annular conductor part 301 transmits a majority of an incident electromagnetic wave of a frequency band f2 and reduces an influence on the electromagnetic wave of the frequency band f2. Therefore, the antenna 30 can reduce, for example, an influence on an operation of a nearly-disposed antenna that operates in the frequency band f2.

As described above, the antenna 30 can reduce a size of an original conductor included in an antenna by a split ring resonator based on the annular conductor part 301. Therefore, when a conductor part is replaced with the FSS 103 in order to have transmission characteristics with respect to an electromagnetic wave of f2, a conductor part to be replaced with the FSS 103 in an antenna in order to have desired transmission characteristics is small. The reason is that even when a portion replaced with the FSS 103 is small, a size of the remaining conductor part can be small since an original antenna size is small and the remaining conductor easily behaves as a small conductor piece. At that time, a conductor part replaced with the FSS 103 can be small, and therefore the antenna 30 is subjected to a smaller characteristic change when a part thereof is replaced with the FSS 103 and a design adjustment can be smaller. In particular, a conductor of a periphery of the split part 305 and a periphery of the void 312 of the center of the annular conductor part 301 largely affects a resonance frequency of the antenna 30, and therefore since the conductor does not need to be replaced with the FSS 103, a design adjustment is smaller.

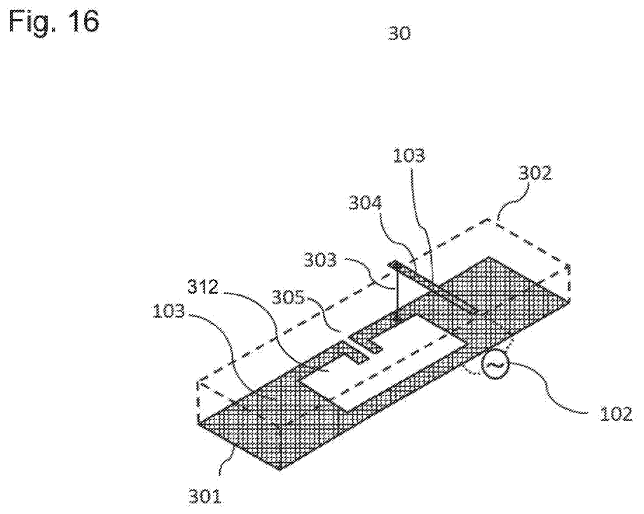

In the antenna 30, the entire annular conductor part 301 may be replaced with the FSS 103 as illustrated in FIG. 16. Further, the conductor feed line 304 may also be replaced with the FSS 103.

The antenna 30 may not necessarily include the dielectric substrate 302.

In FIG. 15, the annular conductor part 301 has a rectangular shape as a whole but does not necessarily have a rectangular shape, and may have a triangular shape, a circular shape, or any shape other than these.

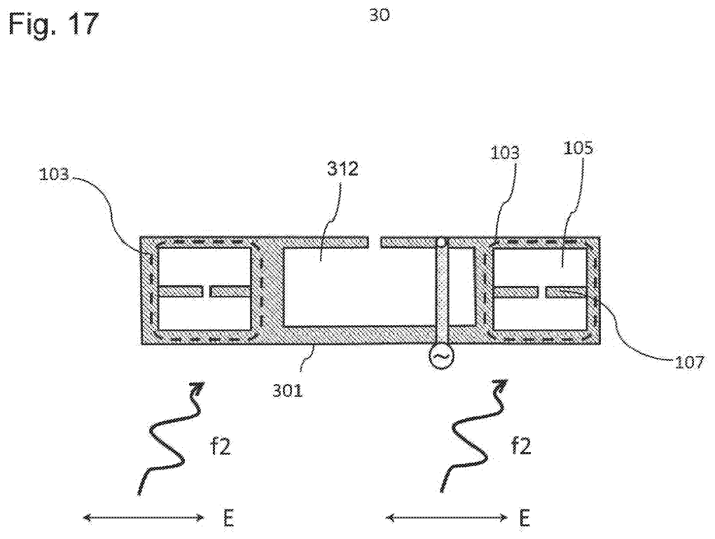

In addition, a modified example of the antenna 30 in the third example embodiment is described by using FIGS. 17 to 22.

FIG. 17 illustrates one form of the modified example of the antenna 30. In FIG. 17, for simplification, illustration of the dielectric substrate 302 is omitted.

As illustrated in FIG. 17, in the antenna 30, as an FSS 103 that replaces a part of an annular conductor part 301, only one unit cell in the FSS 103 illustrated in FIG. 6 may be used. In this case, a size of a unit cell, used as an FSS 103, of the FSS 103 illustrated in FIG. 6 may be approximately a size of a short side of a rectangular annular conductor part 301. At that time, a conductor part 107 included in the FSS 103 may include only a conductor part 107 that increases a capacitance between conductors opposed to each other in a longitudinal direction of the annular conductor part 301 in conductors opposed with each other across a void part 105 in conductors opposed to each other across a void part 105. In this case, transmission characteristics of an electromagnetic wave of a frequency band f2 having an electric field E parallel to a longitudinal direction of the annular conductor part 301 are adjusted by the conductor part 107.

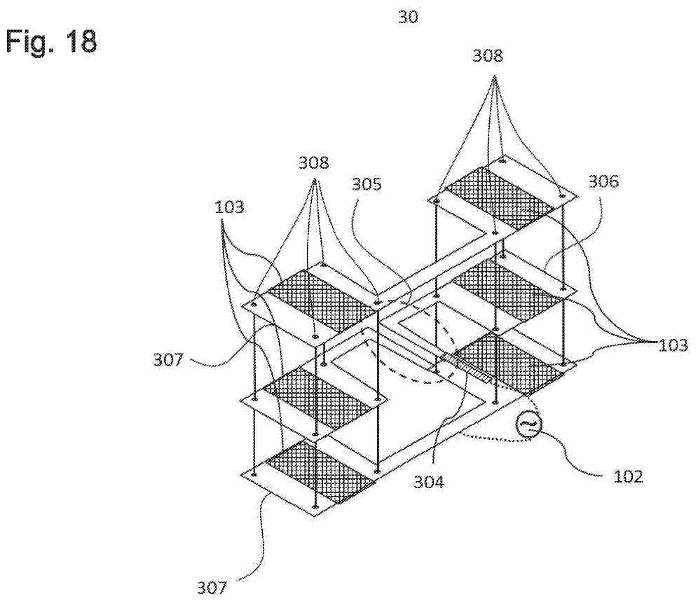

FIG. 18 illustrates one form of the modified example of the antenna 30. As illustrated in FIG. 18, an antenna 30 includes, instead of the annular conductor part 301, a conductor part 306, a plurality of conductor parts 307, and a conductor via 308 that electrically connects the conductor part 306 and the plurality of conductor parts 307. In the conductor part 306 and the plurality of conductor parts 307, the plurality of conductor parts 307 are laminated in such a way as to sandwich the conductor part 306. A dielectric substrate 302 may be provided between the conductor part 306 and the plurality of conductor parts 307. The conductor part 306, the plurality of conductor parts 307, and the conductor via 308 form an annular conductor across a plurality of layers. A part or the whole of the conductor part 306 and each of the plurality of conductor parts 307 includes an FSS 103.

In the antenna 30 illustrated in FIG. 18, the conductor part 306 includes a split part 305. Ends of the conductor part 306 opposed to each other via the split part 305 are bent in a direction of the void 312 of the center of an annular conductor and are extended up to an opposite side of the void 312. When conductor portions opposed to each other in the split part 305 are increased, a capacitance in a resonance of a split ring can be increased. A conductor feed line 304 connects one of the extended ends of the conductor part 306 and a feeding point 102.

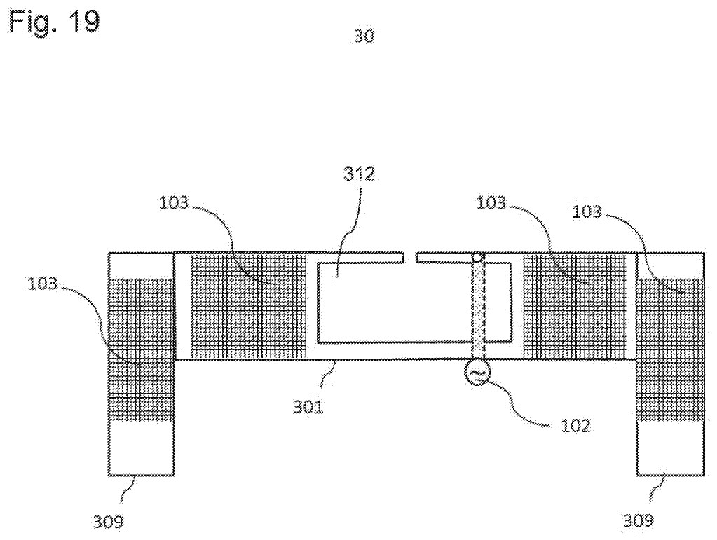

FIG. 19 illustrates one form of the modified example of the antenna 30. As illustrated in FIG. 19, an antenna 30 further includes a radiating conductor 309 at both ends of a longitudinal direction of an annular conductor part 301. By using such a configuration, a current component in a longitudinal direction of the annular conductor part 301 contributing to radiation can be guided to the radiating conductor 309, and therefore radiation efficiency can be enhanced. As illustrated in FIG. 19, a part or the whole of the radiating conductor 309 includes an FSS 103.

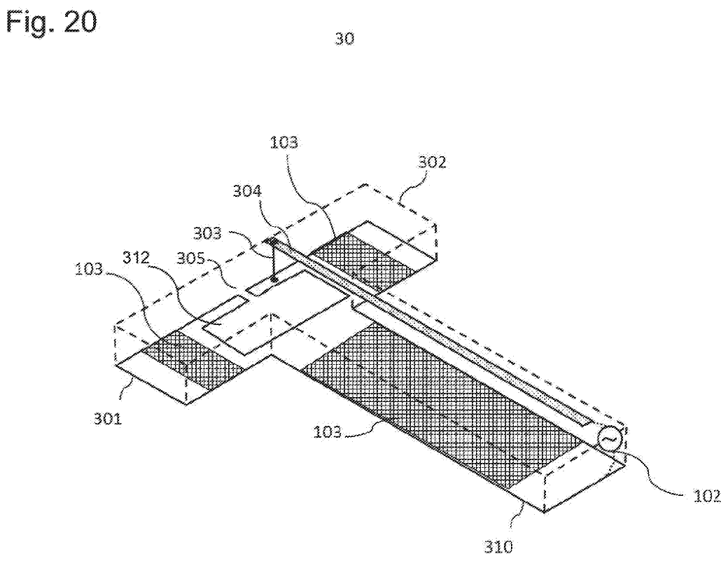

FIG. 20 illustrates one form of the modified example of the antenna 30. As illustrated in FIG. 20, in an antenna 30, a conductor part 310 is further electrically connected to an edge opposed to a split part 305 of an annular conductor part 301 across a void 312, the edge being a central part of a longitudinal direction of the annular conductor part 301. At that time, the annular conductor part 301 and the conductor part 310 form a substantially T-shaped conductor. A conductor feed line 304 is provided in such a way as to be opposed to the annular conductor part 301 and the conductor part 310 via a dielectric substrate 302. One end of the conductor feed line 304 is electrically connected to a vicinity of a split part 305 of the annular conductor part 301. When viewed from a direction where the annular conductor part 301, the dielectric substrate 302, and the conductor feed line 304 are laminated, the conductor feed line 304 is disposed in such a way as to straddle the void 312. The other end of the conductor feed line 304 is extended toward an edge opposed to an edge connected to the annular conductor part 301 of the conductor part 310. The conductor feed line 304 and the conductor part 310 form a feed line to the conductor part 310. A feeding point 102 is provided between the extended other end of the conductor feed line 304 and the conductor part 310. A part or the whole of the conductor part 310 may be replaced with an FSS 103.

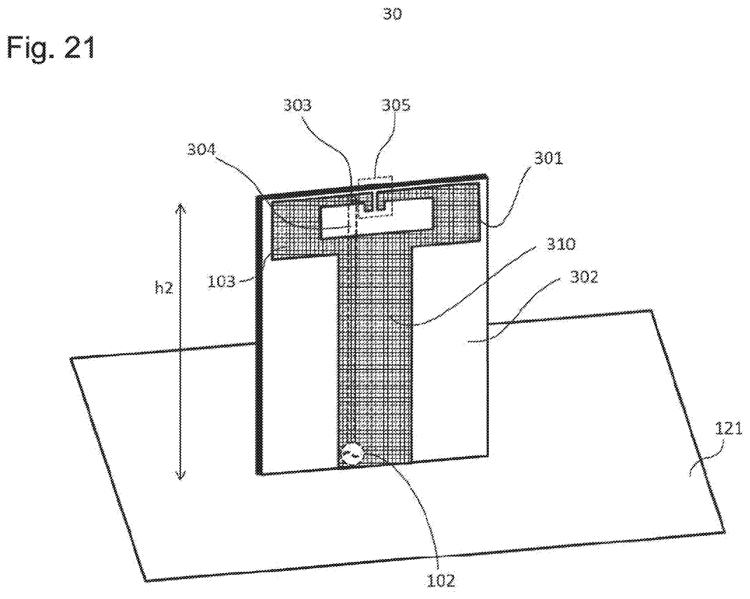

As illustrated in FIG. 21, an antenna 30 illustrated in FIG. 20 may be disposed substantially upright relative to a conductor reflection plate 121. At that time, the extended conductor feed line 304 and the conductor part 310 can be regarded as a feed line that supplies electric power to the annular conductor part 301 from a conductor reflection plate 121 side. Note that the dielectric substrate 302 may be rectangular as illustrated in FIG. 21. Further, commonly, a distance h2 between an upper end of the annular conductor part 301 and the conductor reflection plate 121 is preferably approximately one quarter of λ1. However, h2 may be shorter, based on a design adjustment of the annular conductor part 301 and the conductor part 310 and metamaterial reflection plate making of the conductor reflection plate 121.

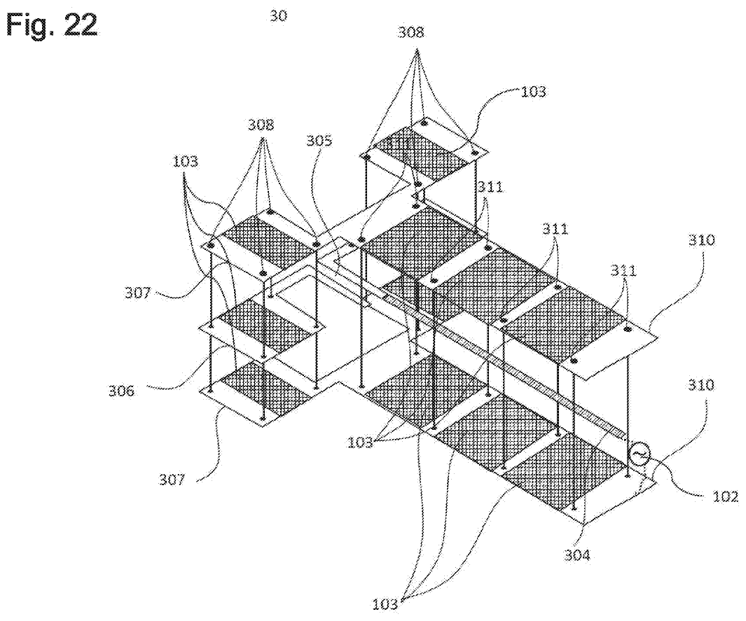

An antenna 30 in FIG. 22 includes, instead of the annular conductor part 301, a conductor part 306, a plurality of conductor parts 307, and a conductor via 308, as in the antenna 30 illustrated in FIG. 18. A dielectric substrate 302 may be provided between the conductor part 306 and the plurality of conductor parts 307. The antenna 30 further includes a plurality of conductor parts 310 and a conductor via 311. The plurality of conductor parts 310 may be connected, for example, to each of the plurality of conductor parts 307. The plurality of conductor parts 310 are connected to each other by the conductor via 311. The conductor via 311 may be formed in such a way as to cover a circumference of a conductor feed line 304. The conductor part 306, each of the plurality of conductor parts 307, and each of the plurality of conductor parts 310 include an FSS 103.

### Fourth Example Embodiment

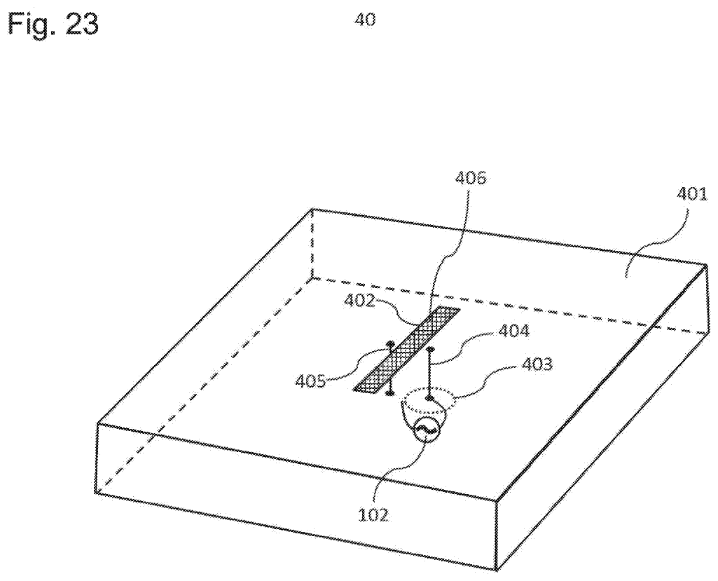

FIG. 23 is a configuration diagram illustrating a configuration of an antenna 40 in a fourth example embodiment of the present invention.

The antenna 40 is different from the first example embodiment in that instead of the dipole antenna in the first example embodiment, a slot antenna that radiates an electromagnetic wave from an opening is used. Referring to FIG. 23, the antenna 40 includes a cavity conductor 401, a rectangular opening (slot) 402 including an FSS 406, an opening 403, conductor vias 404 and 405, and a feeding point 102. In the present example embodiment, the same component as in other example embodiments is assigned with the same reference sign, and therefore detailed description is omitted.

Hereinafter, components included in the antenna 40 in the fourth example embodiment are described.

The cavity conductor 401 includes the rectangular opening (slot) 402 on one surface. The cavity conductor 401 includes the opening 403 on the other surface opposed to the surface where the rectangular opening (slot) 402 is included. The antenna 40 is supplied with electric power via the opening 403. Specifically, the conductor via 404 going through the opening 403 goes through an interior of the cavity conductor 401 and is connected to the cavity conductor 401 of a long side portion of the rectangular opening (slot) 402. The conductor via 405 goes through an interior of the cavity conductor 401 and connects the cavity conductor 401 in a circumference of the opening 403 and the cavity conductor 401 of another long side portion of the rectangular opening (slot) 402. At that time, the conductor via 404 and the conductor via 405 are opposed to each other via the rectangular opening (slot) 402. Note that, a feeding method is not limited to a case in which the opening 403 mediates, and another feeding method such as patch excitation may be used.

The rectangular opening (slot) 402 includes an FSS 406.

The FSS 406 has a nature that mainly transmits an incident electromagnetic wave of a frequency band f1 and reflects an incident electromagnetic wave of a frequency band f2. The FSS 406 may have a structure that selectively transmits an electromagnetic wave of a frequency band f1, for example, as in a structure illustrated in FIGS. 6 to 12, or may have a structure that selectively reflects an electromagnetic wave of a frequency band f2, for example, as in a structure illustrated in FIG. 13.

An operation and an effect of the antenna 40 according to the fourth example embodiment is described.

Commonly, a size of a rectangular opening (slot) of a slot antenna that operates in a frequency band f1 is approximately one half of λ1 and is larger than one half of λ2 (in the case of f1<f2). Therefore, while a conductor portion of a cavity conductor behaves as a conductor wall for an electromagnetic wave of a frequency band f2, the rectangular opening (slot) 402 behaves as a surface having characteristics different from the conductor wall. Therefore, a rectangular opening (slot) regards a cavity as a conductor wall, e.g. a reflection plate and produces a non-negligible influence on characteristics of an antenna that operates in a frequency band f2 disposed in a vicinity of a slot antenna.

In the antenna 40 according to the fourth example embodiment, the rectangular opening (slot) 402 includes an FSS 406.

The FSS 406 has characteristics that transmit an electromagnetic wave of a frequency band f1. Therefore, the rectangular opening (slot) 402 behaves as an opening for an electromagnetic wave of a frequency band f1 and does not inhibit an operation of the antenna 40 in the frequency band f1. Further, the FSS 406 has a nature that reflects an electromagnetic wave in a frequency band f2. As a result, the rectangular opening (slot) 402 behaves, for the frequency band f2, substantially equally to a conductor part of the cavity conductor 401 including the rectangular opening (slot) 402. As a result, the rectangular opening (slot) 402 can reduce an influence on an antenna that operates in a frequency band f2 disposed in a vicinity of the antenna 40.

While as the antenna 40 according to the present example embodiment, a slot antenna is used as an antenna that radiates an electromagnetic wave from an opening included in a conductor in FIG. 23, the antenna 40 may be an antenna using another opening.

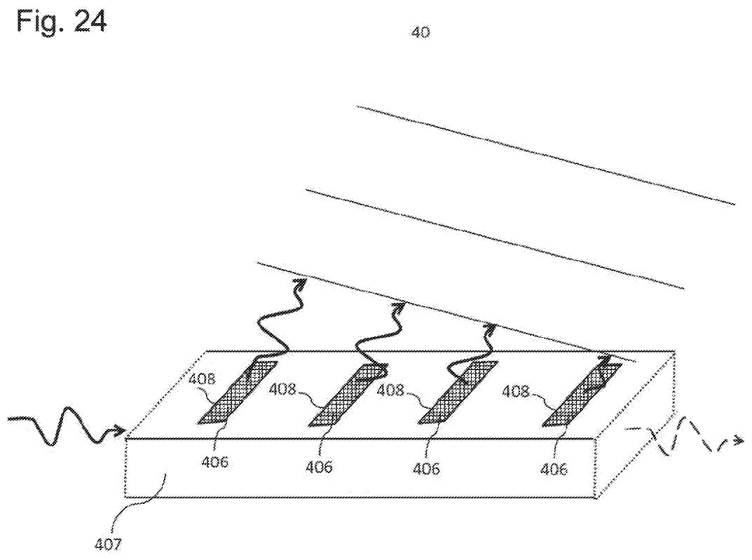

Then antenna 40 may be, for example, a leakage wave antenna as illustrated in FIG. 24. An antenna 40 in FIG. 24 includes a conductor line 407 and includes a plurality of openings 408 on one surface of the conductor line 407. Each opening 408 includes an FSS 406. The antenna 40 radiates an electromagnetic wave, based on leakage of an electromagnetic wave traveling in the conductor line 407 from a plurality of openings 408. The antenna 40 may be configured, for example, in such a way as to strongly perform radiation in a certain specific direction by setting a phase difference of electromagnetic waves leaking from openings 408 adjacent to each other to be constant. Note that, the conductor line 407 may include any line configuration besides a waveguide, such as a coaxial line.

### Fifth Example Embodiment

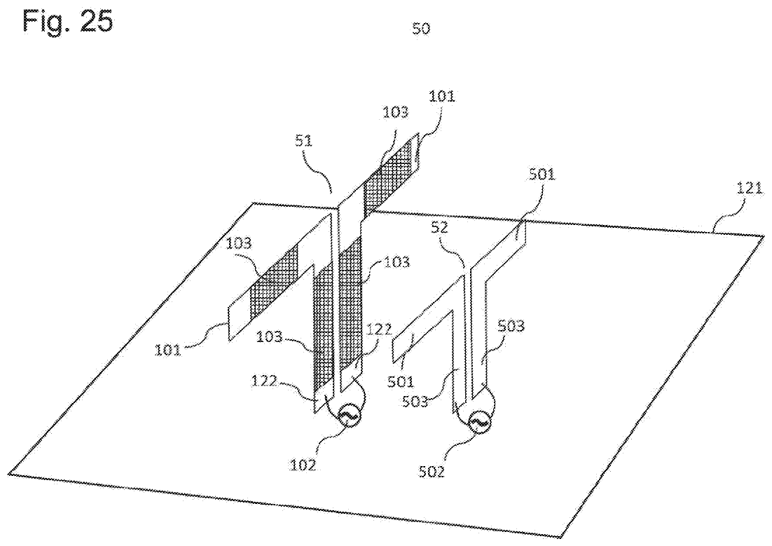

FIG. 25 is a configuration diagram illustrating a configuration of a multiband antenna 50 in a fifth example embodiment of the present invention. In the present example embodiment, the same component as in other example embodiments is assigned with the same reference sign, and therefore detailed description is omitted.

The multiband antenna 50 includes an antenna 51 that operates in a frequency band f1 and an antenna 52 that operates in a frequency band f2 disposed in a neighborhood of the antenna 51. Referring to FIG. 25, the multiband antenna 50 includes two dipole antennas that are the antenna 51 and the antenna 52.

Hereinafter, components included in the multiband antenna 50 in the fifth example embodiment are described.

As illustrated in FIG. 25, the antenna 51 includes two radiating conductors 101, similarly to the configuration illustrated in FIG. 5 and forms a dipole antenna that operates in a frequency band f1. The antenna 51 includes a feeding point 102 and two feed-line conductor parts 122, similarly to the configuration illustrated in FIG. 5. The radiating conductor 101 and the feed-line conductor part 122 include an FSS 103. In the antenna 51, illustration of a dielectric substrate 120 is omitted.

The antenna 52 includes two radiating conductors 501, a feeding point 502, and two feed-line conductor parts 503, similarly to the antenna 51, as a dipole antenna that operates in a frequency band f2. In the antenna 52, illustration of a dielectric substrate 120 is omitted. Commonly, a size of a longitudinal direction of the antenna 52 is approximately one half of λ2, based on two radiating conductors 501.

The antennas 51 and 52 are disposed on a conductor reflection plate 121, similarly to the configuration illustrated in FIG. 5, as illustrated in FIG. 25. At that time, as described in FIG. 5, commonly, a distance between the radiating conductor 101 and the conductor reflection plate 121 is substantially one quarter of λ1. Further, commonly, a distance between the radiating conductor 501 and the conductor reflection plate 121 is substantially one quarter of λ2.

An operation and an effect of the multiband antenna 50 according to the fifth example embodiment is described.

Commonly, upon configuring a small multiband antenna in response to a demand resulting from mounting on a device, appearance, and the like, when antennas that operate in frequency bands f1 and f2 are intended to be configured closely to each other, an influence mutually produced on both antennas, specifically, an influence of an antenna of a frequency band f1 on an antenna of a frequency band f2 increases. In other words, a distance between both antennas is limited according to predetermined performance, and therefore it is difficult to configure a small multiband antenna.

On the other hand, in the multiband antenna 50, the antenna 51 includes a major portion of an FSS 103, similarly to the first example embodiment and transmits a majority of an incident electromagnetic wave of a frequency band f2, and thereby reduces a change of a state of the electromagnetic wave of the frequency band f2. Therefore, an influence of the antenna 51 that operates in a frequency band f1 on an operation of the antenna 52 that operates in a frequency band f2 can be reduced.

The multiband antenna 50 includes the antenna 52 that operates in a frequency band f2 in a neighborhood (e.g. one half or less of λ2) of the antenna 51. At that time, the antenna 52 is not excessively affected by the antenna 51 due to the effect described above. When f1<f2, a size of the antenna 52 in a longitudinal direction is approximately one half of λ2 and is smaller than one half of λ1. Thereby, the antenna 51 is unlikely to be subjected to an influence as a conductor of the antenna 52. Therefore, the multiband antenna 50 can reduce an influence mutually produced on two antennas 51 and 52 that operate in frequency bands f1 and f2, respectively, and these antennas can be disposed at a short distance. In other words, the multiband antenna 50 can be achieved as a small antenna as a whole.

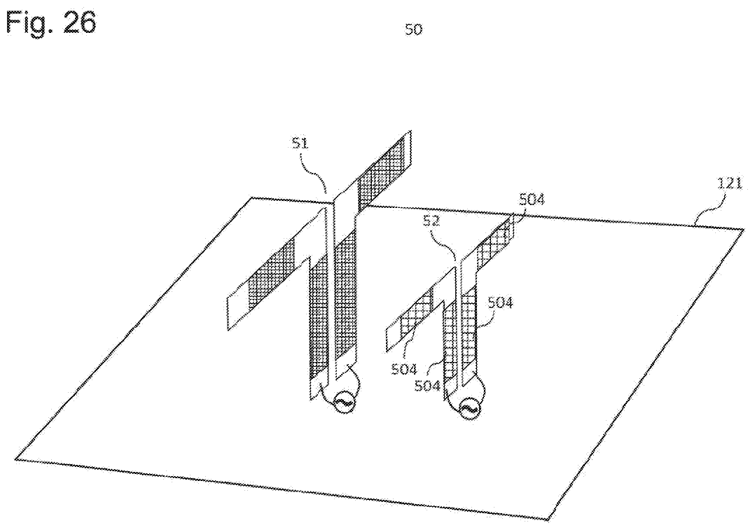

An influence of the antenna 52 on the antenna 51 depends only on a fact that a size of the antenna 52 is small, and therefore a conductor in the antenna 52 may include an FSS 504, as illustrated in FIG. 26, depending on a size and predetermined characteristics of the antenna 52. In other words, a part or the whole of a conductor of the antenna 52 may be replaced with an FSS 504. The FSS 504 has characteristics that transmit a majority of an electromagnetic wave of a frequency band f1, based on a configuration as illustrated in FIGS. 6 to 13.

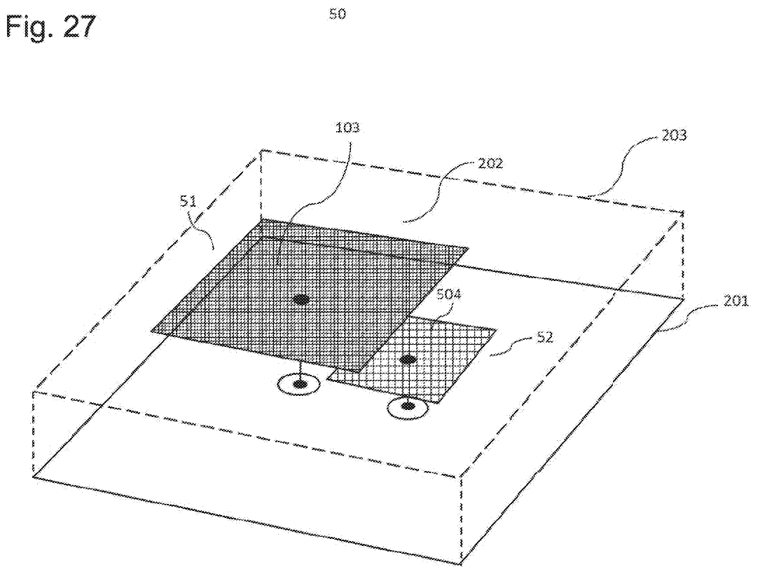

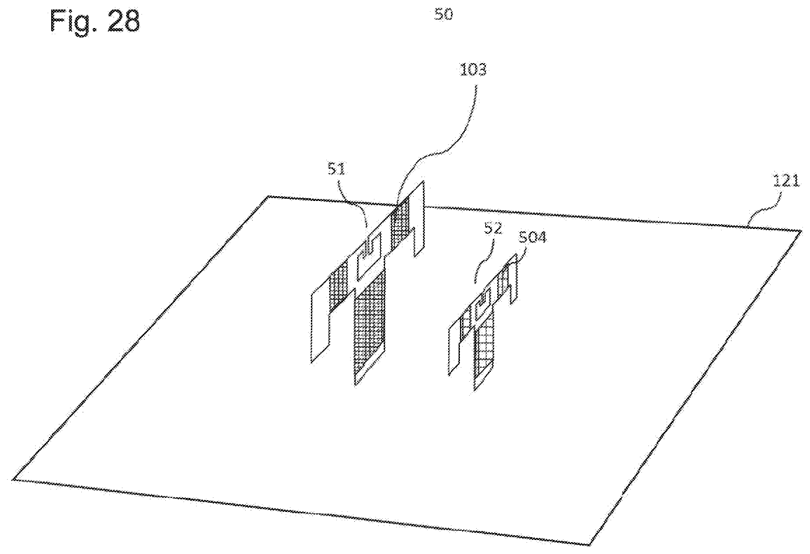

Further, while in FIGS. 25 and 26, as the antenna 51 and the antenna 52, a dipole antenna is used, a type of an antenna is not limited to a dipole antenna. The antennas 51 and 52 may be, for example, a patch antenna as illustrated in FIG. 14 described in the second example embodiment, as illustrated in FIG. 27 or an antenna using a split ring resonator described in the third example embodiment, as illustrated in FIG. 28. In FIG. 28, illustration of a dielectric substrate 302 and a conductor feed line 304 is omitted.

### Sixth Example Embodiment

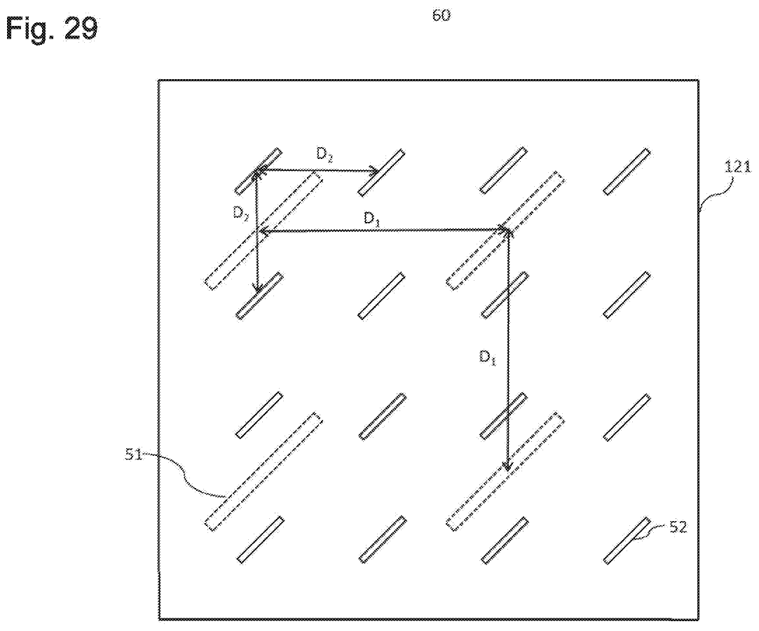

FIG. 29 is a configuration diagram illustrating a configuration of a multiband antenna array 60 in a sixth example embodiment of the present invention. In the present example embodiment, the same component as in other example embodiments is assigned with the same reference sign, and therefore detailed description is omitted.

The multiband antenna array 60 includes a plurality of antennas 51 that operate in a frequency band f1 described in the fifth example embodiment and a plurality of antennas 52 that operate in a frequency band f2 also described in the fifth example embodiment. In FIG. 29, the multiband antenna array 60 uses, as the antenna 51 and the antenna 52, an antenna of a configuration as illustrated in FIGS. 25, 26, and 28.

Hereinafter, components included in the multiband antenna array 60 and an operation and an effect thereof are described.

As illustrated in FIG. 29, the multiband antenna array 60 includes, as illustrated in FIG. 29, a plurality of antennas 51 arranged at a substantially equal interval at a distance D1 in two directions and a plurality of antennas 52 arranged at a substantially equal interval at a distance D2 in two directions on a conductor reflection plate 121. An array area of the antenna 51 and an array area of the antenna 52 are overlapped when viewed from directly above of the conductor reflection plate 121. Such a disposition is made, and thereby a multiband antenna array can be configured with less area, compared with when an antenna array is provided in a separate area with respect to each different frequency.

Further, at that time, the antenna 51 and the antenna 52 are closer to each other than the distances D1 and D2. However, the antenna 51 and the antenna 52 close to each other can reduce a mutual influence, based on the effect of the FSS 103 and the FSS 504 as described in the fifth example embodiment, and therefore a multiband array can be configured by using a small area as in FIG. 29.

Note that, in FIG. 29, the antenna 51 and the antenna 52 are arranged at an equal interval in a square array manner, but an arrangement method is not limited thereto. A rectangular disposition, a triangular disposition, or a circular disposition is applicable, and an unequal interval is also applicable. Further, the distances D1 and D2 are preferably approximately one half of λ1 and one half of λ2, respectively, in order to cause antennas not to be excessively close to each other and reduce an influence of a grating lobe during operation as an antenna array. However, a value is not limited thereto.

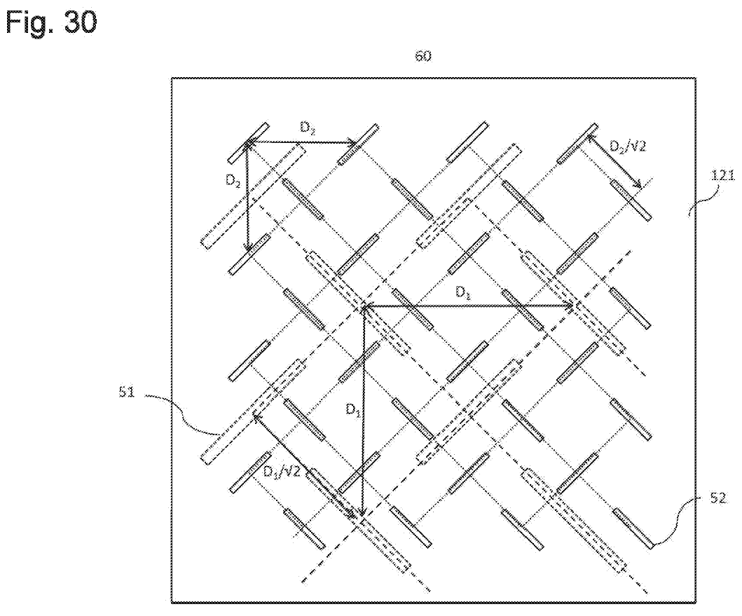

Further, in FIG. 29, the antenna 51 and the antenna 52 are arranged in a direction where these antennas are substantially parallel to each other, but a direction is not limited thereto. Further, as illustrated in FIG. 30, in addition to an array arranged in a direction parallel to a certain one direction, elements directed in a direction vertical to the certain one direction are also disposed in an array manner similarly. At that time, a distance between antennas 51 and a distance between antennas 52 being closest to each other are 1/√2 of D1 and 1/√2 of D2, respectively, in FIG. 30, but are not limited thereto.

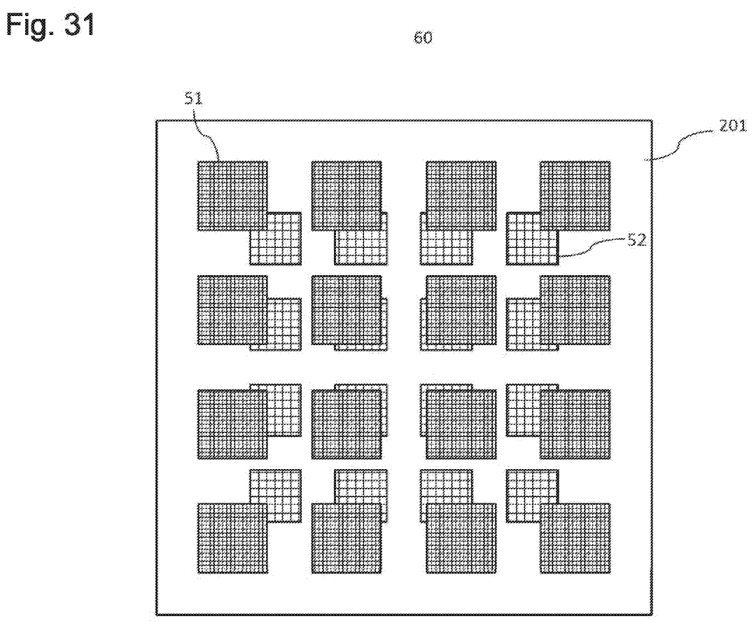

In addition, the multiband antenna array 60 may be configured by using the patch antenna illustrated in FIG. 27 as the antenna 51 and the antenna 52, as illustrated in FIG. 31. At that time, the antenna 51 and the antenna 52 may be arranged in such a way as to be overlapped when viewed from directly above of a conductor reflection plate 201, as illustrated in FIG. 31.

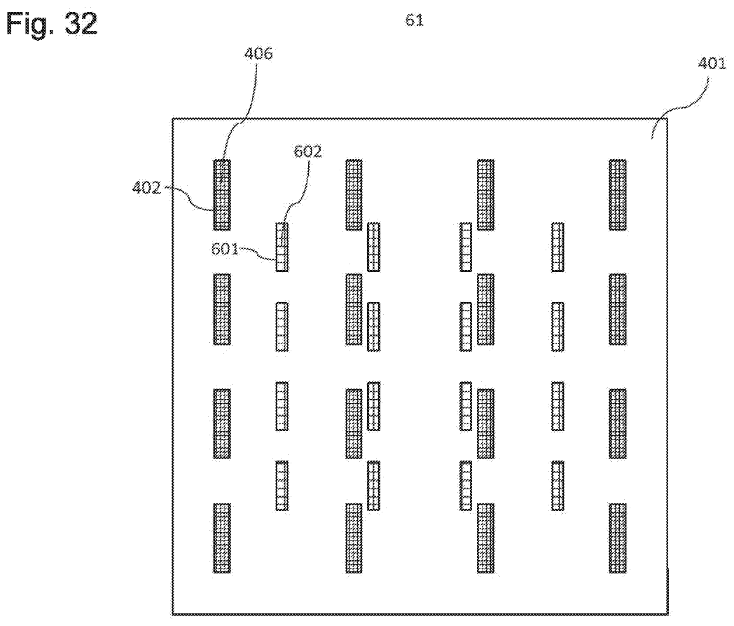

In addition, as a modified example of the multiband antenna array according to the present example embodiment, a configuration as in a multiband antenna array 61 illustrated in FIG. 32 is applicable. In the multiband antenna array 61, the slot antenna of FIG. 23 described in the fourth example embodiment is arranged in an array manner as an antenna that operates in a frequency band f1. Further, in the multiband antenna array 61, a slot antenna that operates in a frequency band f2 including a configuration similar to the slot antenna illustrated in FIG. 23 is arranged in an array manner in such a way as to be overlapped with an array area of the slot antenna that operates in the frequency band f1 when viewed from directly above of a cavity conductor 401.

The above-described slot antenna that operates in a frequency band f1 behaves substantially the same as a conductor surface with respect to an antenna that operates in a frequency band f2 disposed in a neighborhood, based on the effect of the FSS 406 as described in the fourth example embodiment. In contrast, in the above-described slot antenna that operates in the frequency band f2, a size of a slot 601 is approximately one half of λ2 and smaller than one half of λ1 (in the case of f1<f2). In other words, the slot 601 has a small opening portion for the frequency band f1 and therefore exhibits a nature substantially the same as a conductor wall. Therefore, slot antennas that operate in the frequency bands f1 and f2 can be disposed at a short distance, and when these slot antennas are arranged as in FIG. 32, a small multiband antenna array can be achieved.

Note that, when the slot 601 further includes an FSS 602, an influence of a slot antenna that operates in a frequency band f2 on a slot antenna that operates in a frequency band f1 can be further reduced. The FSS 602 has characteristics that transmits mainly an incident electromagnetic wave of the frequency band f2 and reflects mainly an incident electromagnetic wave of the frequency band f1.

### Seventh Example Embodiment

A wireless communication device 70 according to a seventh example embodiment is described.

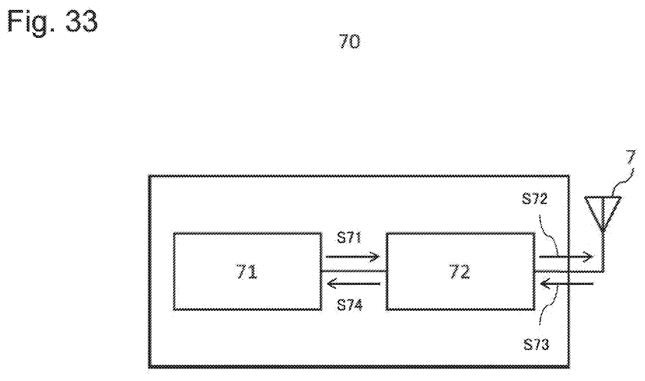

FIG. 33 is a block diagram schematically illustrating a configuration of the wireless communication device 70 according to the seventh example embodiment. The wireless communication device 70 includes a multiband antenna 7, a base band (BB) unit 71, and a radio frequency (RF) unit 72.

The BB unit 71 handles at least one of a transmission signal S71 before modulation or a reception signal after demodulation, these signals each being a BB signal.

The RF unit 72 converts a BB signal to an RF signal or converts an RF signal to a BB signal. The RF unit 72 may modulate a transmission signal S71 received from the BB unit 71 and output a transmission signal S72 after modulation to the multiband antenna 7. The RF unit 72 may demodulate a reception signal S73 received by the multiband antenna 7 and output a reception signal S74 after demodulation to the BB unit 71.

The multiband antenna 7 includes the multiband antenna 50 of the fifth example embodiment or the multiband antenna array 60 or 61 of the sixth example embodiment. The multiband antenna 7 may radiate a transmission signal S72. The multiband antenna 7 may receive a reception signal S73 radiated by an external antenna.

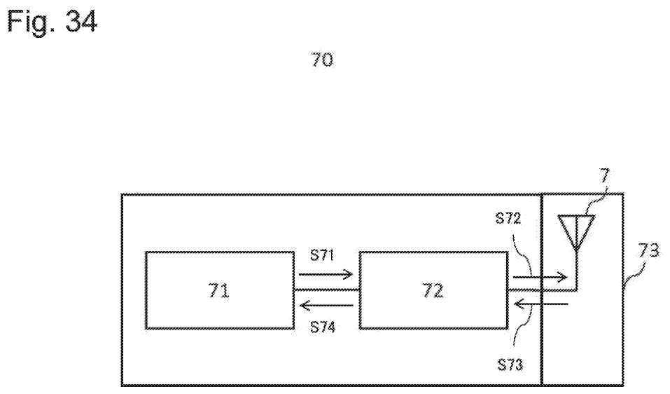

The wireless communication device 70 of the present example embodiment may further include, as illustrated in FIG. 34, a radome 73 that mechanically protects the multiband antenna 7. The radome 73 commonly includes a dielectric.

As described above, it can be understood that according to the present configuration, the wireless communication device 70 capable of wirelessly communicating with an outside can be specifically configured by using the multiband antenna 7.

While several example embodiments of the present invention have been described, these example embodiments have been presented as examples and are not intended to limit the scope of the present invention. These example embodiments can be carried out by other various forms and can be subjected to omissions, replacements, and modifications without departing from the gist of the present invention. It should be understood that these example embodiments and variations thereof are included in the scope and gist of the present invention and are also included in the present invention as defined by the claims and the scope of equivalents thereof.

This application is based upon and claims the benefit of priority from Japanese patent application No. 2017-071244, filed on Mar. 31, 2017, the disclosure of which is incorporated herein in its entirety by reference.

### REFERENCE SIGNS LIST

10 Antenna

101 Radiating conductor

102 Feeding point

103 FSS

120 Dielectric substrate

121 Conductor reflection plate

122 Feed-line conductor part

104, 107 Conductor part

105 Void part

106 Unit cell

108, 109 Meander-like conductor part

110 Conductor via

111 Dielectric part

112, 113, 114 Conductor part

115 Linear conductor part

116 Conductor patch

117 Open stub

118 Conductor pin

119 Conductor patch

1030 FSS

20 Antenna

201 Conductor reflection plate

202 Conductor patch

203 Dielectric substrate

204 Conductor via

205 Void part

30 Antenna

301 Annular conductor part

302 Dielectric substrate

303 Conductor via

304 Conductor feed line

305 Split part

306, 307, 310 Conductor part

308, 311 Conductor via

309 Radiating conductor

312 Void

40 Antenna

401 Cavity conductor

402, 403, 408 Opening

404, 405 Conductor via

406 FSS

407 Conductor line

50 Multiband antenna

51, 52 Antenna

501 Radiating conductor

502 Feeding point

503 Feed-line conductor part

504 FSS

60 Multiband antenna array

601 Slot

602 FSS

70 Wireless communication device

7 Multiband antenna

71 BB unit

72 RF unit

73 Radome

What is claimed is:

1. An antenna an operation frequency of which is in a first frequency band, comprising:
a radiating conductor including a frequency selective surface; and a feeding part that supplies electric power to the radiating conductor, wherein
the frequency selective surface transmits an electromagnetic wave of a second frequency band being different from the first frequency band.

2. The antenna according to claim 1, wherein the radiating conductor further includes a conductor piece having a size of less than one half of a wavelength of the second frequency band.

3. The antenna according to claim 1, wherein a part of the frequency selective surface includes a periodical structure of a conductor part and a void part.

4. The antenna according to claim 1, wherein a wavelength of the second frequency band is shorter than a wavelength of the first frequency band.

5. The antenna according to claim 1, wherein the antenna is a dipole antenna or a patch antenna.

6. The antenna according to claim 1, wherein
the antenna is a split ring antenna,
the radiating conductor further includes an annular conductor part notched by a split part,
the feeding part supplies electric power to the annular conductor part via a feed line,
one end of the feed line is electrically connected to a vicinity of the split part of the annular conductor part, and
the feed line is disposed in such a way as to straddle a void being configured by the annular conductor part.

7. The antenna according to claim 1, wherein the frequency selective surface reflects an electromagnetic wave of the first frequency band.

8. A multiband antenna comprising:
a first antenna an operation frequency of which is in a first frequency band, the first antenna including a first radiating conductor;
a second antenna an operation frequency of which is in a second frequency band being different from the first frequency band, the second antenna including a second radiating conductor; and
a feeding part that supplies electric power to the first radiating conductor and the second radiating conductor, wherein
the first radiating conductor includes a frequency selective surface that transmits an electromagnetic wave of the second frequency band.

9. The multiband antenna according to claim 8, wherein the second radiating conductor includes a second frequency selective surface that transmits an electromagnetic wave of the first frequency band.

10. A wireless communication device comprising:
a BB unit that outputs a base band (BB) signal;
an RF unit that converts the BB signal to a radio frequency (RF) signal and outputs the RF signal; and
the antenna according to claim 1 to which the RF signal is input.

11. A wireless communication device comprising:
a BB unit that outputs a base band (BB) signal;
an RF unit that converts the BB signal to a radio frequency (RF) signal and outputs the RF signal; and
the multiband antenna according to claim 8 to which the RF signal is input.
